(19) United States
(12) Patent Application Publication
(10) Pub. No.: US 2026/0209010 A1
(43) Pub. Date: Jul. 23, 2026

(54) CRANE SYSTEM

(71) Applicant: Samsung Electronics Co., Ltd., Suwon-si (KR)

(72) Inventors: Dawoon Jung, Suwon-si (KR); Taeyoung Kang, Suwon-si (KR); Sun-Nyeon Kim, Suwon-si (KR); Juil Kim, Suwon-si (KR); Seongtae Park, Suwon-si (KR); Jaegeun Cho, Suwon-si (KR)

(21) Appl. No.: 19/270,191

(22) Filed: Jul. 15, 2025

(30) Foreign Application Priority Data
Jan. 17, 2025 (KR) 10-2025-0007278

(51) Int. Cl. B66C 17/00

(52) U.S. Cl. CPC B66C 17/00

(57) ABSTRACT

A crane system disposed on top of a building may include a pair of girders disposed in parallel along a first direction, a pair of hoists disposed and moving on the pair of girders, and configured to lift a heavy object up and down, and a rail supported by an upper end of a structure disposed on a building roof, disposed in a second direction perpendicular to the first direction, and serving as a path along which the pair of girders moves.

### CROSS-REFERENCE TO RELATED APPLICATION

This application claims priority to and the benefit of Korean Patent Application No. 10-2025-0007278 filed with the Korean Intellectual Property Office on Jan. 17, 2025, the entire contents of which are incorporated herein by reference.

### BACKGROUND

In semiconductor fabrication facilities (FAB), refrigerators that act as air conditioners and cooling towers that act as outdoor units are installed to maintain a constant temperature and humidity.

Cooling towers are installed on the roof of a building, and maintenance of the cooling towers is done by using a mobile crane installed on the ground outside the building. However, the risk of safety accidents occurring during the process of installing and using mobile crane equipment can be a serious concern.

In addition, it can take several days to install and dismantle a mobile crane, making it difficult to respond immediately to maintenance work when the cooling tower requires maintenance. Accordingly, problems arise where the refrigeration load of semiconductor fabrication facilities (FABs) is not managed appropriately, resulting in the interruption of production of semiconductor products.

In addition, as semiconductor fabrication facilities (FABs) have become larger and more advanced, technology that maximizes production area per building footprint has become increasingly important. To maximize production area, technology is being developed to build taller buildings housing semiconductor fabrication facilities (FABs).

In the case of conventional mobile cranes that are installed on the ground, as the height of the building increases, the height of the crane must also increase, so it becomes more difficult to install a crane in a tall building. Accordingly, maintenance work on cooling towers installed in high-rise buildings also becomes difficult.

When semiconductor manufacturing facility (FAB) buildings become taller, maintenance of cooling towers is expected to become more difficult than before, so a crane system that is easy to install and use regardless of the height of the building is required.

### SUMMARY

The present disclosure provides a crane system capable of immediately responding to maintenance of a cooling tower by using a crane regardless of the building height by using a crane system permanently installed on the top of a building, thereby solving the problem of semiconductor production interruption.

In addition, the present disclosure provides a crane system that is installed on a pipe rack supporting cooling tower pipes of a building roof to reduce a need for additional structures for installing the crane, thereby reducing the time and cost required for installation of the crane system.

In addition, the present disclosure provides a crane system installed and operated over a plurality of buildings, where the crane system is capable of performing maintenance work with respect to the entire cooling tower spread over multiple buildings.

A crane system disposed on top of a building may include a pair of girders disposed in parallel along a first direction, a pair of hoists disposed and moving on the pair of girders, and configured to lift a heavy object up and down, and a rail supported by an upper end of a structure disposed on a building roof, disposed in a second direction perpendicular to the first direction, and serving as a path along which the pair of girders moves.

A crane system disposed on top of a building may include a pair of girders disposed in parallel along a first direction, a pair of hoists disposed and moving on the pair of girders, and configured to lift a heavy object up and down, a support unit supporting a roof structure of the building, and a rail disposed in a second direction perpendicular to the first direction on an upper end of the support unit, and serving as a path along which the pair of girders moves along the second direction.

A crane system disposed on top of a plurality of buildings may include a pair of girders disposed in parallel along a first direction, a pair of hoists disposed and moving on the pair of girders, and configured to lift a heavy object up and down, a plurality of support units supporting roof structures of the plurality of buildings, and a rail supported by the plurality of support units upper end, disposed in a second direction perpendicular to the first direction, and serving as a path along which the pair of girders moves.

In some implementations, as the crane system may be installed on top of the cooling tower by utilizing the cooling tower structure, a maintenance work of a cooling tower may be performed by using a crane permanently installed regardless of the building height, and thereby additional structures may be minimized, thereby reducing the installation cost of the crane system.

### BRIEF DESCRIPTION OF THE DRAWINGS

FIG. 1 is a drawing showing a front view of an example of a crane system according to some implementations.

FIG. 2 is a drawing showing a plan view of an example of a crane system according to some implementations.

FIG. 3 is a drawing showing a girder moving in the crane system according to FIG. 2.

FIG. 4 is a drawing showing a front view of a crane system according to some implementations.

FIG. 5 is a drawing showing a hoist in a crane system according to some implementations.

### DETAILED DESCRIPTION

Hereinafter, the present disclosure will be described in detail hereinafter with reference to the accompanying drawings, in which embodiments of the present disclosure are shown.

As those skilled in the art would realize, the described embodiments may be modified in various different ways, all without departing from the spirit or scope of the present disclosure.

The drawings and description are to be regarded as illustrative in nature and not restrictive. Like reference numerals designate like elements throughout the specification.

In addition, size and thickness of each constituent element in the drawings are arbitrarily illustrated for better understanding and ease of description, the following embodiments are not limited thereto. In the drawings, the thickness of layers, films, panels, regions, etc., are exaggerated for clarity. In the drawings, the thickness of some layers and regions may be exaggerated for ease of description.

Throughout this specification and the claims that follow, when it is described that an element is “coupled” to another element, it includes not only the case of being “directly coupled” but also “indirectly coupled” with another element therebetween.

In addition, unless explicitly described to the contrary, the word “comprise”, and variations such as “comprises” or “comprising”, will be understood to imply the inclusion of stated elements but not the exclusion of any other elements.

It will be understood that when an element such as a layer, film, region, area, or substrate is referred to as being “on” or “above” another element, it can be directly on the other element or intervening elements may also be present. In contrast, when an element is referred to as being “directly on” another element, there are no intervening elements present.

Further, when an element is referred to as being “on” or “above” a reference element, it can be positioned above or below the reference element, and it is not necessarily referred to as being positioned “on” or “above” in a direction opposite to gravity.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Conventionally, commonly used cranes were mobile cranes installed on the ground outside of buildings, and the mobile cranes were used to perform tasks such as maintenance of cooling towers.

Recently, as semiconductor fabrication facilities (FABs) have become larger, the buildings in which semiconductor fabrication facilities (FABs) are installed are becoming increasingly tall. As building heights increase, the installation height of mobile crane equipment must also increase, which increases the risk of safety accidents.

In addition, as the height of the building increases, it becomes difficult to install a crane, and thus, maintenance work on the cooling tower becomes difficult.

In particular, since it takes a certain amount of time to install a mobile crane on the ground, there is a problem in that if a problem occurs with the cooling tower, it is difficult to immediately proceed with cooling tower maintenance work.

When installing a crane on top of a building rather than on the ground, an additional structure installed to support the crane and the associated costs can be significant.

Here, the additional structure can refer to a base configuration for fixing and installing the frame of the crane, including a vertical support supported on the ground. Even when installing a crane on top of the building, vertical supports supported on the ground and additional supports supported on the roof of the building can be utilized.

When installing a crane on the top of a building, the movement path of workers on the roof of the building may be affected by additional supports installed on the roof of the building resulting in limited space.

A crane system 10 according to the present disclosure relates to an overhead crane installed on top of a building. The crane system 10 can mitigate problems associated with the conventional crane installation process and with the maintenance process of cooling towers installed on high floors.

The crane system 10 according to some embodiments of the present disclosure is described in detail with reference to the drawings.

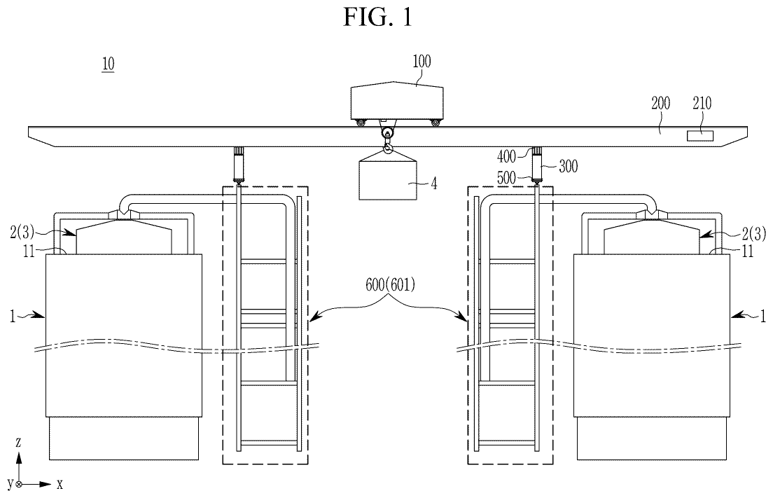

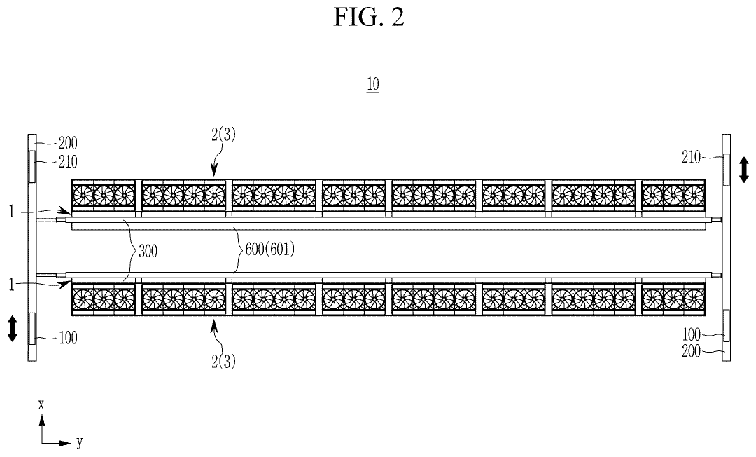

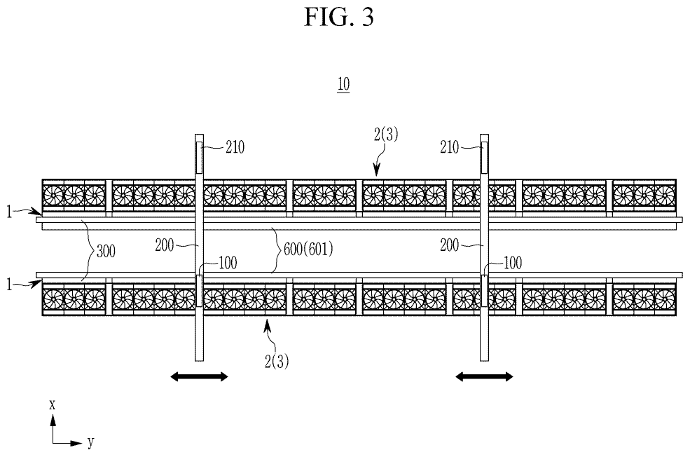

FIG. 1 is a drawing showing a front view of the crane system according to some embodiments, FIG. 2 is a drawing showing a plan view of the crane system according to some embodiments, and FIG. 3 is a drawing showing a girder moving in the crane system according to FIG. 2.

As shown in FIG. 1 and FIG. 2, the crane system 10 according to some embodiments is an overhead crane system 10 disposed on top of a building 1, and may include a pair of hoists 100, a pair of girders 200, and a rail 300.

The hoist 100 may serve to lift a heavy object 4 up and down. The hoist 100 may be provided as a pair, to be disposed on the pair of girders 200, respectively.

The pair of girders 200 may be disposed in parallel along a first direction (x direction). Referring to FIG. 1 and FIG. 2, the pair of girders 200 having a length may be disposed parallel to each other along the x direction, respectively.

Each girder 200 among the pair of girders 200 may include a girder drive 210 enabling each girder 200 to be movable in a second direction (y direction) along the rail 300.

The girder drive 210 may be a power source including a motor, and by the girder drive 210, the girder 200 may move toward the second direction (y direction).

FIG. 1 illustrates a front view, in which only one girder 200 is shown, but the girder drive 210 may also be disposed on the non-illustrated remaining one girder 200 (see FIG. 2). That is, the crane system 10 may include a pair of girder drives 210 enabling the pair of girders 200 to each move along the rail 300.

The rail 300 may be supported by an upper end of a structure 3 disposed higher than the height of the building 1, and extend in the second direction (y direction) perpendicular to the first direction (x direction). Specifically, the rail 300 may be structured to be supported by the upper end of the structure 3 disposed on a roof 11 of the building 1.

FIG. 2 illustrates an embodiment in which two rails 300 are disposed along the structure 3. In some embodiments, the crane system can include more than two rails 300.

The rail 300 may extend along the y direction, and may define a path along which the pair of girders 200 moves. The movement of the pair of girders 200 along the rail 300 is discussed further with reference to FIG. 2 and FIG. 3.

The crane system 10 may include a wheel 400 configured to allow the pair of girders 200 to move on the rail 300.

As shown in FIG. 1, the wheel 400 may be positioned in a portion where an upper end of the rail 300 and a lower portion of the girder 200 overlap or are in contact. By a rotation of the wheel 400, the girder 200 may move on the rail 300.

FIG. 3 is a drawing showing movement of the girder 200 shown in FIG. 2.

As shown in FIG. 3, the pair of hoists 100 are disposed on the pair of girders 200, respectively.

The pair of girders 200 may horizontally move along the y direction, which is the second direction (see, e.g., FIG. 2 and FIG. 3). Accordingly, the hoist 100 disposed on the girder 200 may also move horizontally and simultaneously with the girder 200. That is, each hoist 100 may move along the movement path of each girder 200.

As shown in FIG. 3, as the girder 200 moves along the second direction (y direction), the girder 200 may be able to move in an entire region of a rooftop 11 of the building 1. That is, the pair of hoists 100 may move in the entire region of the rooftop 11.

In some embodiments, the structure 3 in the crane system 10 may include a cooling tower 2.

Referring to FIG. 2 and FIG. 3, a plurality of cooling towers 2 are arranged in two rows, where each row can include two or more cooling towers 2.

The hoist 100 is movable on the girder 200 along the first direction (x-axis direction) (see FIG. 2), enabling maintenance of the cooling tower 2 in a first row and the cooling tower 2 a second row.

In addition, first, after performing maintenance on the cooling towers 2 disposed on both sides among the cooling towers 2 arranged along the second direction (y-axis direction), in order to perform maintenance on the intermediately disposed cooling towers 2, the girder 200 may move along the second direction (y-axis direction) (see FIG. 3).

As such, the hoist 100 in the crane system 10 according to the present disclosure is movable over the entire area where the plurality of cooling towers 2 are disposed.

Since a pair of girders 200 exist in the crane system 10, in situations where the hoist 100 disposed on one girder 200 malfunctions or needs maintenance, the maintenance of the cooling tower 2 may be possible by another hoist 100.

Accordingly, the crane system 10 can quickly respond to a request for maintenance of the cooling tower 2.

Conventionally, when a certain time is required for the process of installing a mobile crane on the ground and some part of the mobile crane malfunctions, the crane can be used only after fixing the part, and the maintenance work of the cooling tower may not proceed during that period.

The girder 200, which defines a path along which the hoist 100 moves, and the rail 300, which defines a moving path of the girder 200, may be considered to serve as a frame supporting the moving hoist 100.

The above-mentioned frame (the girder 200 and the rail 300) according to the present disclosure may not be installed on the rooftop 11 of the building 1 by using a separate support, but installed to be supported by the upper end of a certain structure 3 existing on the rooftop 11.

Accordingly, in comparison with conventional installation of a mobile crane, the need for structural reinforcement for installation of the crane system 10 according to the present disclosure may be reduced, and therefore, the time and the cost for installing a crane system may also be reduced.

In addition, as a support or the like may not be installed on the bottom of the rooftop 11, the movement path of the workers is not affected and there are not restrictions on the use of the space of the rooftop 11.

In some embodiments, the crane system 10 according to the present disclosure may further include a connection unit 500 disposed between the rail 300 lower end and the upper end of the structure 3. The connection unit 500 may serve to connect the rail 300 to the upper end of the structure 3, and to support the rail.

The connection unit 500 is in contact with the rail 300 lower end and the upper end of the structure 3, and any structure capable of supporting and fixing each is possible.

It is desirable that the connection unit 500 be made of minimum configuration. The crane system 10 according to the present disclosure is purposed to reduce the structural reinforcement needed for installation.

The structure 3 in the crane system 10 according to the present disclosure may include the cooling tower 2. Here, the rail 300 supported by the upper end of the structure 3 may mean the rail 300 supported on an upper end of the cooling tower 2.

Specifically, the rail 300 may be supported by an upper end of a support unit 600 supporting the cooling tower 2. Here, the support unit 600 by which the rail 300 is supported may be disposed at a position higher than a height of the cooling tower 2.

When the support unit 600 is disposed at a position that is the same as or lower than the height of the cooling tower 2, there is a possibility of damage due to collision of the girder 200 and the top of the cooling tower 2 while the girder 200 moves along the rail 300 supported by the support unit 600.

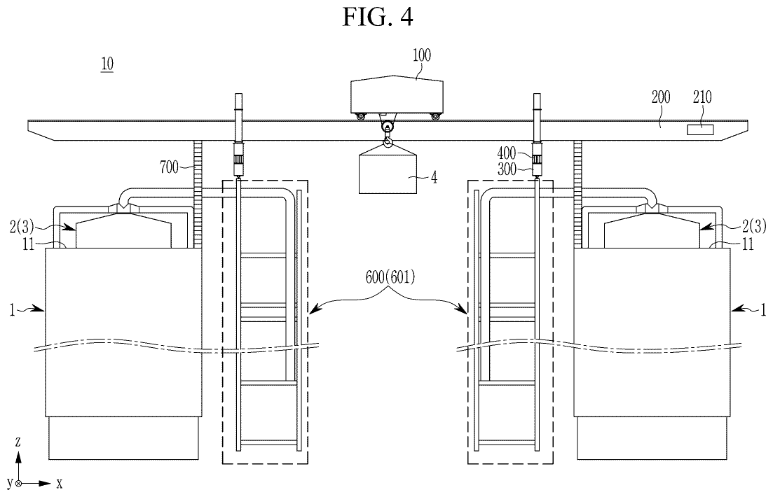

FIG. 4 is a drawing showing a front view of the crane system according to some embodiments.

The plan view of the crane system 10 according to FIG. 4 is the same as what is shown in FIG. 2, and the description below may refer to FIG. 2 and FIG. 4 together.

As shown in FIG. 4, the crane system 10 according to some embodiments is the crane system 10 disposed on top of the building 1, and may include the pair of hoists 100, the pair of girders 200, the support unit 600, and the rail 300.

In the same way as in FIG. 1, the pair of hoists 100 may serve to lift the heavy object 4 up and down.

The pair of girders 200, which define a path on which the pair of hoists 100 are disposed and move, may be disposed in parallel along the first direction (x direction).

The support unit 600 may serve to support the structure 3 (i.e., the cooling tower 2) disposed on the rooftop 11 of the building 1. The upper end of the support unit 600 may be disposed higher than the upper end of the structure 3 (i.e., the cooling tower 2) disposed on the rooftop 11.

The support unit 600 may include a pipe rack 601, which is the structure 3 for supporting pipes of the cooling tower 2.

The pipe rack 601 may include a structure configured to support the pipes of the cooling tower 2. The pipe rack 601 illustrated in FIG. 4 is an illustration of a certain example with simplification. The pipe rack 601 is not limited to what is illustrated.

The rail 300 may be disposed in the second direction (y direction) perpendicular to the first direction (x direction), on the upper end of the support unit 600. The rail 300 may serve as a path along which the pair of girders 200 moves.

As shown in FIG. 4, the wheel 400 may be disposed in a portion where the upper end of the rail 300 and a lower portion of the pair of girders 200 overlap or are in contact with each other. The wheel 400 may serve to enable the pair of girders 200 to be movable on the rail 300.

The girder 200 illustrated in FIG. 4 may have a different form from the girder 200 illustrated in FIG. 1.

As shown in FIG. 4, a structure protruding in a vertical direction may be further included in the girder 200. In this case, the structure protruding downward from the girder 200 may be disposed to correspond to the upper end of the rail 300, and the wheel 400 may be disposed between the protruding structure of the girder 200 and the upper end of the rail 300.

However, the form of the girder 200 is not limited to what is illustrated in FI 1 and FIG. 4.

FIG. 2 and FIG. 3 illustrate an embodiment in which two rails 300 are disposed. However, the number of rails 300 but is not limited thereto. The rail 300 may be disposed in a plurality. The plurality of rails 300 may be disposed in parallel to be spaced apart. The number of the rails 300 is not limited.

As the number of rails 300 increases, the force with which the crane system 10 is supported on the building 1 may be strengthened, and the girder 200 disposed on the rails 300 can be disposed more stably.

However, since the rail 300 must be disposed on the upper end of the support unit 600 including the pipe rack 601, the position and the number of rails 300 that can be installed may be limited.

A module rack (e.g., a walk way) means a moving path from the rooftop 11 toward the hoist 100 and the girder 200 in order to maintain a hoist drive 110, which is a power source of the hoist 100, and the girder drive 210, which is a power source of t he girder 200.

The crane system 10 according to the present disclosure may further include a module rack 700 disposed close to the pair of girders 200 or the rail 300, from the rooftop 11.

FIG. 4 illustrates that the module rack 700 extends from the rooftop 11 to the girder 200, but it is not limited thereto. The module rack 700 may be disposed to extend from the rooftop 11 to an uppermost end of the pipe rack 601.

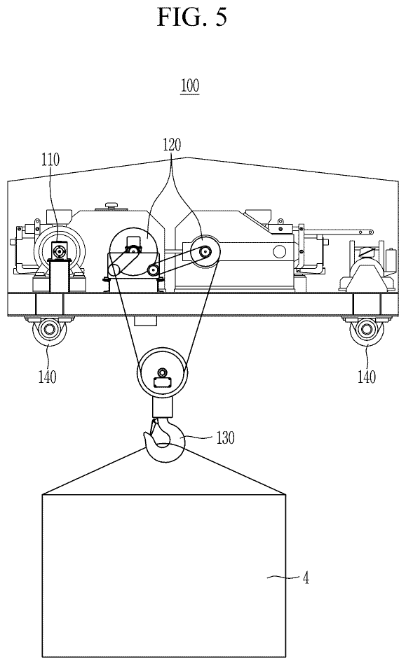

FIG. 5 is a drawing showing the hoist in the crane system according to some embodiments.

As shown in FIG. 5, each hoist 100 may include the hoist drive 110 configured to enable the hoist 100 to be movable on the girder 200.

The hoist drive 110 is a power source that enables the hoist 100 to move straight on the girder, and may include a motor.

In some embodiments, a plurality of wheels 140 may be included in the hoist 100, and in this case, a groove (not shown) along which the wheel 140 can move while rotating may be further provided on the upper surface of the girder 200 in contact with the wheel 140 of the hoist 100.

Each hoist 100 may further include a lifting unit 120 configured to lift the heavy object 4 up and down. The lifting unit 120 may serve as a lift configured to lift the heavy object 4 up and down.

A hook 130 connected to the lifting unit 120 and provided on a lower end of the hoist 100 may extend downward. After fixing the heavy object 4 on the hook 130 extending downward, by moving back the hook 130 upward, the heavy object 4 may be lifted up and down.

In some embodiments, the crane system 10 according to the present disclosure may be an overhead crane system for maintenance of the cooling tower 2, and may include the pair of hoists 100, the pair of girders 200, the pipe rack 601, the rail 300, and the wheel 400.

The pair of hoists 100 may lift the heavy object 4 up and down. The hoist 100 in the crane system 10 according to the present disclosure is purposed to lift the heavy object 4 of the cooling tower 2 up and down for maintenance of the cooling tower 2. The heavy object 4 of the cooling tower 2 may include all objects related to the maintenance of the cooling tower 2.

The pair of girders 200, which is a path on which the pair of hoists 100 are disposed and move, may be disposed in parallel along the first direction (x direction).

The pipe rack 601 may mean a structure configured to support the pipes of the cooling tower 2, and an upper end of the pipe rack 601 may be characterized to be disposed higher than the height of the cooling tower 2.

The rail 300 may be disposed in the second direction (y direction) perpendicular to the first direction (x direction), on the upper end of the pipe rack 601. One or more rails 300 may be disposed, which may be a path along which the pair of girders 200 moves.

The wheel 400 may be disposed in a portion where the upper end of the rail 300 and the lower portion of the pair of girders 200 intersect or are in contact with each other, and may serve to enable the pair of girders 200 to be movable on the rail 300.

In some embodiments, the crane system 10 may further include the connection unit 500. The connection unit 500 may be disposed between the rail 300 and the upper end of the pipe rack 601, and may serve to support the rail 300 to the pipe rack 601.

However, the connection unit 500 may not be necessarily included.

In some embodiments, a structure that can be coupled to the pipe rack 601 may be included in a portion of the rail 300 that is in contact with the pipe rack 601. That is, the rail 300 itself may be coupled to the pipe rack 601.

In the crane system 10 according to the present disclosure, the building 1 includes a plurality of cooling towers 2 (a plurality of sub-structures 3) arranged in a matrix of n rows x m columns. As used herein, the term “plurality of sub-structures 3” (also referred to as “plurality of sub-roof structures”, “sub-structures,” or “sub-roof structures”) refers to the portions of the structure 3 (also referred to as “roof structure 3”) that are arranged in the form of a matrix with n rows and m columns. The rail 300 may be disposed along the second direction (y direction), which is a direction in which each of the n rows is aligned.

A length of the rail 300 along the second direction (y direction) may be greater than or equal to a length of n rows on which the cooling towers 2 (the sub-structures 3) are arranged.

According to FIG. 2 and FIG. 3, the cooling towers 2 (the sub-structures 3) are disposed in two rows x 28 columns, and the length of the rail 300 along the second direction (y direction) is greater than or equal to a length of a second row of the cooling towers 2 (the sub-structures 3).

The cooling towers 2 (the sub-structures 3) are arranged in a matrix of n rows x m columns. The pair of girders 200 may be disposed along the first direction (x direction) in which the cooling towers 2 (the sub-structures 3) in each of the m columns are aligned.

A length of the girder 200 along the first direction (x direction) may be greater than or equal to a length of m columns on which the cooling towers 2 (the sub-structure 3) are arranged.

Specifically, the length of the girder 200 along the first direction (x direction) may be greater than or equal to a distance from a center of a first row of the cooling towers 2 (the sub-structures 3) to a center of an n-th row of the cooling towers 2 (the sub-structures 3), for the cooling towers 2 (the sub-structures 3) arranged along m columns.

Referring to FIG. 2 and FIG. 3, it may be seen that the cooling towers 2 (the sub-structure 3) are disposed in two rows×28 columns, and the length of the girder 200 along the first direction (x direction) is greater than or equal to the distance from the center of the first row of the cooling towers 2 (the sub-structures 3) in the arrangement of the cooling towers 2 (the sub-structures 3) to the center of the second row of the cooling towers 2 (the sub-structures 3).

As described above, the region where the girder 200 and the rail 300 are disposed, which means a region in which the hoist 100 may move in the crane system 10 according to the present disclosure, may be disposed over the entire area of the plurality of cooling towers 2 (the plurality of sub-structures 3).

Accordingly, the hoist 100 may be able to move over the entire area where the plurality of cooling towers 2 (the plurality of sub-structures 3) are disposed, and an immediate response is available when the maintenance is required for the entire cooling tower 2.

The crane system 10 according to the present disclosure may further include a pair of hoist drives 110 configured to enable each hoist 100 to be movable on the pair of girders 200.

Since the pair of hoists 100 are independently movable, even if one of them is stopped due to an error, another one of the hoists 100 may proceed with the maintenance work of the cooling tower 2.

Each hoist 100 may further include the lifting unit 120 configured to lift the object 4 up and down.

In addition, the crane system 10 according to the present disclosure may include the pair of girder drives 210 enabling the pair of girders 200 to move along the rail 300.

In some embodiments, the crane system 10 according to the present disclosure is the crane system disposed on top of the building 1, and may include the pair of hoists 100, the pair of girders 200, the support unit 600, the rail 300.

In some embodiments, the crane system 10 may be characterized in that the crane system 10 is integrally installed on the rooftop 11 over a plurality of buildings 1.

The pair of girders 200 may be mutually parallel along the first direction. The pair of hoists 100 may be moved on the pair of girders 200, and can be configured to lift the object 4 up and down.

In some embodiments, since a plurality of buildings 1 are included, a plurality of support units 600 may be disposed so as to support a roof structure 3 of the plurality of buildings 1.

The rail 300 may be disposed in the second direction perpendicular to the first direction. The rail 300 can define a path along which the pair of girders 200 moves, and may be supported by upper ends of a plurality of support units 600.

At least one of the pair of girders 200 and the rail 300 is connected in an upper portion of the plurality of buildings 1 that are spaced apart. That is, at least one of the pair of girders 200 and the rail 300 is connected to the plurality of buildings 1.

Referring to FIG. 2, two buildings 1 are disposed.

FIG. 2 illustrates a structure in which the buildings 1 are spaced apart in the x-axis direction, and the cooling tower 2 (structure 3) is on top of each building 1. That is, FIG. 2 illustrates an embodiment in which the pair of girders 200 are disposed to be connected in the upper portion of the spaced apart plurality of buildings 1.

In some embodiments, the rail 300 may be connected to the upper portion of the spaced apart plurality of buildings 1.

In some embodiments, the crane system 10 is integrally installed on and operates over the plurality of buildings 1.

By installing a single crane system 10 on top of the plurality of cooling towers 2 that are positioned on respective buildings 1 spaced apart from each other, the maintenance work of the entire cooling tower 2 may be performed.

Since the crane system 10 may be installed on the pipe rack 601 of the conventional cooling tower 2, the need for separate additional components for installation of the crane system 10 can be reduced, and the time and cost needed for the installation may be reduced.

In particular, by being installed on top of the cooling tower 2, interference during the operation of the cooling tower may be reduced.

In addition, since the crane system 10 maintains a state of being permanently installed on top of the cooling tower 2, crane system 10 can be used to quickly respond to a request for maintenance of the cooling tower 2.

In addition, by lifting up and down the heavy object 4 required for maintenance of the cooling tower 2 by using the pair of hoists 100 that are independently movable, the efficiency in terms of the time and cost required for the maintenance of the cooling tower 2 may be increased.

Accordingly, the stability of utility supply for semiconductor product fabrication may be improved.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While this disclosure has been described in connection with what is presently considered to be practical embodiments, it is to be understood that the disclosure is not limited to the disclosed embodiments, but, is intended to cover various modifications and equivalent arrangements included within the spirit and scope of the appended claims.

What is claimed is:

1. A crane system disposed on top of a building, the crane system comprising:
a pair of girders that extend in parallel along a first direction;
a pair of hoists configured to move on the pair of girders, and configured to lift an object up and down; and
a rail supported by an upper end of a structure on a building roof, wherein the rail extends in a second direction that is perpendicular to the first direction, and wherein the rail defines a path for movement of the pair of girders.

2. The crane system of claim 1, wherein each hoist among the pair of hoists comprises a hoist drive configured to move a respective hoist on the pair of girders.

3. The crane system of claim 1, wherein each hoist among the pair of hoists comprises a lifting unit configured to lift the object up and down.

4. The crane system of claim 1, wherein each girder of the pair of girders comprises a respective girder drive configured to move the girder along the rail.

5. The crane system of claim 1, comprising a wheel between an upper end of the rail and lower portions of the pair of girders, wherein the wheel is configured to move the pair of girders on the rail.

6. The crane system of claim 1, comprising a connection unit between the rail and the upper end of the structure, wherein the connection unit is configured to support the rail over the structure.

7. A crane system disposed on top of a building, the crane system comprising:
a pair of girders that extend in parallel along a first direction;
a pair of hoists configured to move on the pair of girders, and configured to lift an object up and down;
a support unit supporting a roof structure of the building; and
a rail that extends in a second direction perpendicular to the first direction on an upper end of the support unit, wherein the rail defines a path for movement of the pair of girders along the second direction.

8. The crane system of claim 7, wherein the upper end of the support unit is higher than an upper end of the roof structure.

9. The crane system of claim 7, wherein the support unit comprises a pipe rack configured to support pipes of a cooling tower disposed on a roof of the building.

10. The crane system of claim 7, comprising a wheel between an upper end of the rail and lower portions of the pair of girders, the wheel configured to move the pair of girders on the rail.

11. The crane system of claim 7, comprising:
a plurality of rails including the rail, wherein the plurality of rails are mutually parallel and spaced apart from one another.

12. The crane system of claim 7, comprising:
a pair of hoist drives configured to move the pair of hoists on the pair of girders; and
a pair of girder drives configured to move the pair of girders along the rail.

13. The crane system of claim 7, comprising a module rack that extends between a roof and a location proximate to the pair of girders or the rail.

14. The crane system of claim 7, wherein
the roof structure comprises a plurality of sub-roof structures arranged in a matrix of n rows x m columns,
each row of the n rows of the plurality of sub-roof structures is aligned in the second direction,
the rail extends along the second direction, and
a length of the rail along the second direction is greater than or equal to a length of the n rows of the plurality of sub-roof structures in the second direction.

15. The crane system of claim 7, wherein
the roof structure comprises a plurality of sub-roof structures arranged in a matrix of n rows×m columns,
each column of the m columns of the plurality of sub-roof structures is aligned in the first direction,
the pair of girders extend along the first direction, and
a length of the girder along the first direction is greater than or equal to a length of the m columns of the plurality of sub-roof structures in the second direction.

16. A crane system disposed on top of a plurality of buildings, the crane system comprising:
a pair of girders that extend in parallel along a first direction;
a pair of hoists configured to move on the pair of girders, and configured to lift an object up and down;
a plurality of support units supporting roof structures of the plurality of buildings; and
a rail supported by the plurality of support units wherein the rail extends in a second direction perpendicular to the first direction, and wherein the rail defines a path for movement of the pair of girders.

17. The crane system of claim 16, wherein the plurality of buildings are spaced apart, and wherein at least one girder of the pair of girders or the rail is connected to an upper portion of at least one building of the plurality of buildings.

18. The crane system of claim 16, comprising a wheel between an upper end of the rail and lower portions of the pair of girders, wherein the wheel is configured to move the pair of girders on the rail.

19. The crane system of claim 16, comprising:
a pair of hoist drives configured to move the pair of hoists on the pair of girders; and
a pair of girder drives configured to move the pair of girders along the rail.

20. The crane system of claim 16, wherein each hoist of the pair of hoists comprises a lifting unit configured to lift the object up and down.
